(19) United States
(12) Patent Application Publication
(10) Pub. No.: US 2026/0235530 A1
(43) Pub. Date: Aug. 13, 2026

(54) LOAD CARRIER CONTROL APPARATUS, OPERATING METHOD AND USE

(71) Applicant: HAVER & BOECKER OHG, Oelde (DE)

(72) Inventor: Dirk BERGMANN, Ostbevern (DE)

(21) Appl. No.: 19/150,703

(22) PCT Filed: Feb. 13, 2024
(86) PCT No.: PCT/EP2024/053552

§ 371 Date: Jul. 24, 2025

(30) Foreign Application Priority Data
Feb. 16, 2023 (DE) 10 2023 103 843.5

(51) Int. Cl. G01N 21/88; B66F 9/06; B66F 9/075; G06T 7/00

(52) U.S. Cl. CPC G01N 21/8851; B66F 9/063; B66F 9/07504; G06T 7/0004; G01N 2021/8887; G06T 2207/20081; G06T 2207/30108

(57) ABSTRACT

A load carrier control apparatus including a control device, the control device including a sensor device and a computing device. The computing device is suitable and designed for using an evaluation based on an automated application to inspect a quality feature of a controllable load carrier on the basis of the data captured by the sensor device the automated application including an AI application and/or at least one computer vision application. The method for operating such a load carrier control apparatus involves using the automated application to infer at least one quality feature and initiating an accordingly predetermined action. The use relates to an automated application including at least one AI application and/or at least one computer vision application for controlling load carriers.

The present invention relates to load carrier control apparatus comprising at least one control device, wherein the control device comprises at least one sensor device and at least one computing device. The present invention also relates to a method for operating such a load carrier control apparatus and to a use thereof.

Load carriers are used to receive objects or even a multiplicity of objects to be transported to ensure standardized transport of these objects. Load carriers can be made of a wide variety of materials and have different shapes and configurations.

For example, there are, e.g., flat pallets made of wood, so-called Euro pallets (EN 13698-1), which have a defined base area of 800 mm×1200 mm.

Such standardized load carriers offer many advantages for the transport of individual objects and/or, e.g., stacked piece goods. This means that usually all industrial trucks can pick up and transport such pallets.

Furthermore, the standardized base area makes it possible, e.g., to select a predetermined layer pattern and/or the bag size in advance in relation to a later layer pattern in a suitable manner when stacking bags on such a pallet.

The construction of load carriers is usually relatively simple. The aforementioned Euro pallets consist of wooden slats and wooden blocks, which are connected in a predetermined arrangement by means of nails.

However, the problem with these pallets is that they can also be damaged during transport. Thus, individual slats can splinter or even break completely, and nails can also protrude towards the loading area.

Protruding parts, e.g., the wooden slats and/or protruding nails, other foreign objects, and/or deformed planks or slats can damage the goods to be transported. Especially when, e.g., bags filled with bulk goods are stacked on a defective pallet, the bags resting directly on the pallet can be damaged and bulk goods can spill out. Depending on the type of bulk material, the resulting dust can contaminate the surrounding area and/or even create a hazardous situation if the bulk material is harmful to health and/or the environment.

If individual slats and/or blocks of the pallet are missing and/or are otherwise deformed, the pallet is usually too unstable to ensure safe transport.

As palletizing is largely automated in many areas, only new and therefore hopefully undamaged pallets are used in certain areas in order to avoid disadvantages caused by defects in the goods being transported. For example, in the case of overseas transports, entire containers are not accepted and returned if the load contains bags filled with bulk material and dust pollution or contamination is detected when the container is opened. This results in considerable costs so that only new pallets are used as a precaution.

However, the use of new pallets in turn results in high costs and a new pallet can also be defective or damaged shortly before automatic loading.

The problem of integrity and/or correct alignment and/or installation, e.g., in the case of collapsible boxes, folding boxes, lattice boxes, racks and/or other such load carriers, is correspondingly critical.

It is therefore the object of the present invention to avoid damage to the load due to defective and/or incorrectly designed and/or load carriers, in particular when using load carriers which have already been used, such as pool pallets, circulation pallets and/or reusable pallets.

This object is achieved by a load carrier control apparatus having the features of claim 1, by a method for operating a load carrier control apparatus having the features of claim 7 and by a use according to claim 12. Preferred refinements of the invention are the subject matter of the subclaims. Further advantages and features of the present inventions are apparent from the general description and the description of the exemplary embodiment.

The load carrier control apparatus according to the invention comprises at least one control device, wherein the control device comprises at least one sensor device and at least one computing device. The computing device is suitable and designed for using an evaluation based on at least one automated application to inspect at least one quality feature of at least the upper side of at least one empty load carrier to be controlled, on the basis of the data captured by the sensor device, wherein the automated application comprises at least one AI application and/or at least one computer vision application.

The fact that an empty load carrier is controlled means in particular that not a packed load carrier, thus, not a load unit comprising a load carrier and packages arranged thereon, is considered, but only an empty or unpacked or unloaded or unfilled load carrier such as, for example, a pallet.

In this case, a load carrier is in particular a standardized load carrier such as a so-called Euro pallet. Depending on their configuration, such load carriers can be made of different materials and have certain other properties such as shape, height and/or receptacles for industrial trucks. A Euro pallet, for example, is usually made of wood and constructed in such a manner that conventional industrial trucks such as, for example, forklift trucks and/or pallet trucks can drive under the pallet or into the pallet and then lift it for further transportation. However, other load carriers can also be made of or comprise other materials and can also vary in shape and other properties.

However, load carriers are also to be understood to include pallets made of other materials and load carriers of different shapes or designs, such as, for example, collapsible boxes, folding boxes, lattice boxes, racks, and/or similar items.

A computing device preferably comprises at least one computer and/or the like, and/or is made available by at least one computer and/or the like.

A quality feature is, in particular, the integrity of the load carrier or at least the upper side of the load carrier on which the goods to be conveyed or the load stands. For example, depending on the design, it is preferably inspected as a quality feature whether all components of the load carrier are present, whether all components are intact or undamaged, and/or whether foreign bodies are protruding from the area of the loading surface or the upper side of the load carrier. In the area of Euro pallets it can be inspected, for example, whether all slats or blocks are present, whether individual slats are broken or splintered, or whether parts of them are sticking up and could penetrate the goods to be loaded, and/or whether nails or other foreign objects or parts of the previous load are protruding from the upper side of the load carrier, which could damage the load. In general, depending on the configuration, it is inspected in particular whether planks, boards and/or the surface are deformed and/or missing, and whether the load carrier and/or the load are/become unstable as a result or whether the load could be damaged.

At least the upper side of the load carrier is inspected or controlled, with the subsequent load standing on the upper side. Preferably, however, the sides and/or the underside of the load carrier are also controlled for damage by means of the load carrier control apparatus.

The load carrier control apparatus according to the invention can be used in particular in the area of loading bags filled with bulk material.

In particular, an automated application is at least one processor-based application or a computer-based application that processes or further processes or analyzes the data captured by the sensor device.

According to the invention, the automated application is at Least one AI application and/or at least one computer vision application and/or comprises at least one of these applications. Computer vision refers in particular to the analysis of images and videos by means of computer programs. The aim of these analyses is in particular the extraction of information contained in the image. Depending on the configuration, probabilistic methods, methods of image processing, projective geometry, deep learning and computer graphics are preferably used.

In the field of AI application, any application in the field of artificial intelligence can be used which can be advantageously used for monitoring with regard to the control of load carriers.

In particular, the use of machine learning (ML) is advantageous here, such machine learning being a subfield of artificial intelligence (AI). A central component of machine learning are algorithms and methods that enable programs to learn from data without being explicitly programmed. This means that these programs can preferably make decisions independently. A distinction is made in particular between supervised, unsupervised and semi-supervised learning. Supervised learning methods include, amongst others, convolutional neural networks (also referred to as space-invariant artificial neural networks) and further developments of convolutional neural networks, such as region-based convolutional neural networks. These modifications of conventional neural networks are particularly suitable for image processing applications since, depending on the configuration, one or more pre-processing steps are carried out prior the neural network such as, amongst others, convolutional operations, depending on the application.

In particular, sensors (e.g., optical sensors such as a camera in color or black and white, thermal image, ...) are used to record data of certain states. These images and their states are then put into context by assigning the corresponding label (tag) to each state (an image =a matrix of information).

A defect in a load carrier detected by the control device can also be used as a further data basis for teaching.

This declared information is then preferably transferred/taught into a CNN (convolutional neural network) using machine learning or AI methods or AI applications.

For example, if a sensor looks at the load carrier, the data is permanently passed through the CNN which evaluates the state directly and the status is further processed by a controller (e.g., defective load carrier detected =load carrier is discarded).

A sensor device can be and/or comprise, for example, a camera device or, depending on the configuration, can also comprise or be configured as an acoustic sensor, a temperature sensor and/or at least one other suitable sensor.

The load carrier control apparatus according to the invention offers many advantages. A considerable advantage is that empty load carriers can be automatically inspected before use or before loading or packing or filling, so that during a subsequent loading process it is ensured that the load carrier itself is in sound condition, or undamaged, or intact.

Whether a load carrier packed with load has predetermined properties or quality features and/or is undamaged can preferably be controlled with an apparatus provided for this purpose or, depending on the configuration, can preferably also be controlled in a separate step with the apparatus according to the invention.

By reliably inspecting the integrity of the load carrier by means of an AI application or a computer vision application, it can be achieved that used load carriers can also be used, in particular for sensitive loads or for sensitive areas of the transport, so that the need to use new and thus very expensive load carriers is eliminated.

As a result, the additional costs for such a load carrier control apparatus can usually be offset very quickly since, on the one hand, the use of used load carriers is much cheaper and, in addition, damage caused by new load carriers can be avoided, in particular in the area of automatic loading or palletizing.

Preferably, the control device is in operative connection with at least one controller, wherein the evaluation of the automated application can be transmitted to the controller. In particular, such a controller can be part of the load carrier control apparatus or be comprised therein. Depending on the configuration, however, the controller can also be a separate component or be assigned to another system which, for example, transports the load carriers. Since the controller can preferably initiate a predetermined action by means of the evaluation of the automated application, it is possible, for example, to eject defective or damaged load carriers from an automated conveyor system for load carriers.

Particularly preferably, the sensor device comprises at least one camera device. By means of such a camera device, images or image data can be recorded, in particular of the upper side of the load carrier to be controlled, so that an evaluation of the images by means of the automated application can be used to reliably conclude whether the load carrier is damaged. In particular, depending on the configuration, the camera detection area not only captures the upper side, but also at least the sides of the load carrier.

Preferably, such a camera device can comprise any suitable type of camera. In particular, the use of a conventional webcam is also possible here.

In expedient configurations, at least one conveyor device for load carriers to be controlled is comprised. For example, such a conveyor device or a transport system for load carriers can be comprised in and/or assigned to the load carrier control apparatus. In this manner, pallets can be conveyed to the location of loading or palletizing by means of the conveyor device and, in particular, automatically controlled for damage, in particular during transport.

In advantageous refinements, the conveyor device is suitable and designed, at least in sections and/or at least temporarily, to (also) release the underside of the conveyed load carrier for control. In particular, this makes it possible to inspect the load carrier for damage from below. Depending on the configuration and structure of the load carrier control apparatus, the entire load carrier can be controlled.

Preferably, the control device is suitable and designed to detect a protruding nail, a broken and/or splintered slat, a foreign object, a deformed and/or damaged surface, and/or a missing component as a quality feature. In particular, it is detected or inspected or evaluated whether the load carrier meets the predetermined requirements or quality provisions. Thus, it is preferably also possible to inspect whether the correct type of pallet is being used.

The method according to the invention is suitable for operating a load carrier control apparatus as described above. In this case, the control device uses the automated application to infer at least one quality feature based on the evaluation of the data from the sensor device and initiates an accordingly predetermined action, wherein the automated application comprises at least one AI application and/or at least one computer vision application.

A predetermined action can in particular be at least one error message, a warning and/or also the ejection or non-use or removal of a load carrier detected as defective.

The same definitions for artificial intelligence and computer vision as previously described for the load carrier control apparatus according to the invention apply here.

The method according to the invention also offers the advantages previously described for the load carrier control apparatus.

Preferably, the automated application inspects the data online. For example, a calculation process can be executed decentrally on multiple computing stations or on a computing application available online using the data for identifying a predetermined event.

Particularly preferably, the automated application is taught by training and/or can be used offline on the computing device. Depending on the configuration, the automated application can initially be taught by training online in order to have computing power as broad and high as possible available for teaching. Depending on the configuration, any further functionality and further learning can also take place locally.

In expedient refinements, the automated application is taught by re-training. This can be done online, offline or using other methods and procedures.

Particularly preferably, a protruding nail, a broken and/or splintered slat, a foreign object and/or a missing component is detected as a quality feature. In particular, it is detected whether the load carrier meets the predetermined requirements or quality features. Preferably, it can also be inspected, for example, whether the correct type of pallet is being used. In the case of collapsible boxes, lattice boxes and/or folding boxes, etc., it can be inspected, for example, whether these are correctly unfolded, or set up, and/or aligned, and/or whether there are missing or defective parts, and/or whether damage and/or a foreign body in the area of the loading surface could cause damage to the load.

The use according to the invention relates to the use of an automated application comprising at least one AI application and/or at least one computer vision application in the control of load carriers.

The use according to the invention also offers the advantages as previously described for the load carrier inspection apparatus according to the invention and the method according to the invention.

Further advantages and features of the present invention are apparent from the exemplary embodiment which is explained below with reference to the accompanying figures.

In the figures:

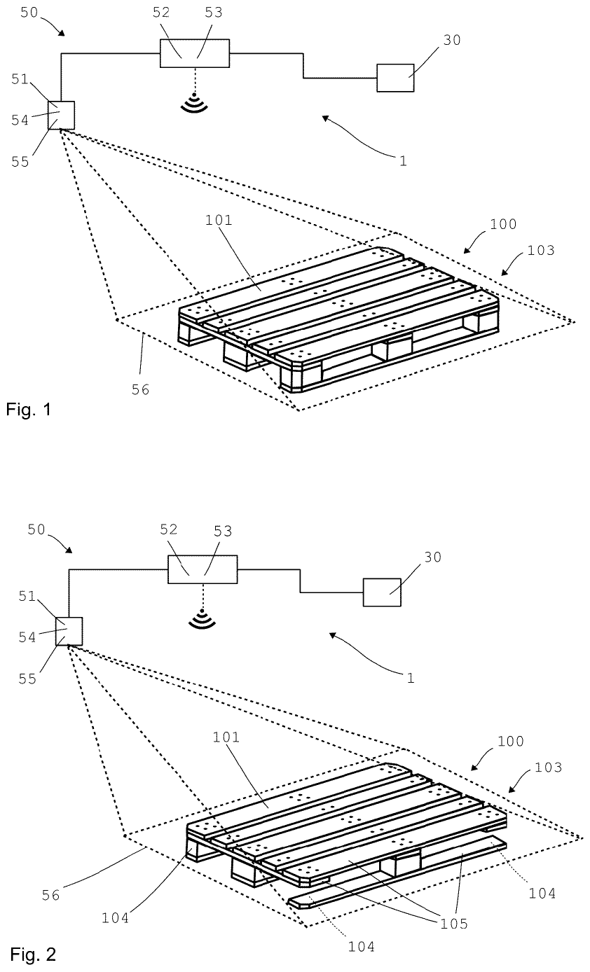

FIG. 1 shows a purely schematic illustration of an exemplary embodiment of a load carrier control apparatus according to the invention with an undamaged load carrier in a perspective view;

FIG. 2 shows a purely schematic illustration of the exemplary embodiment according to FIG. 1 with a defective load carrier;

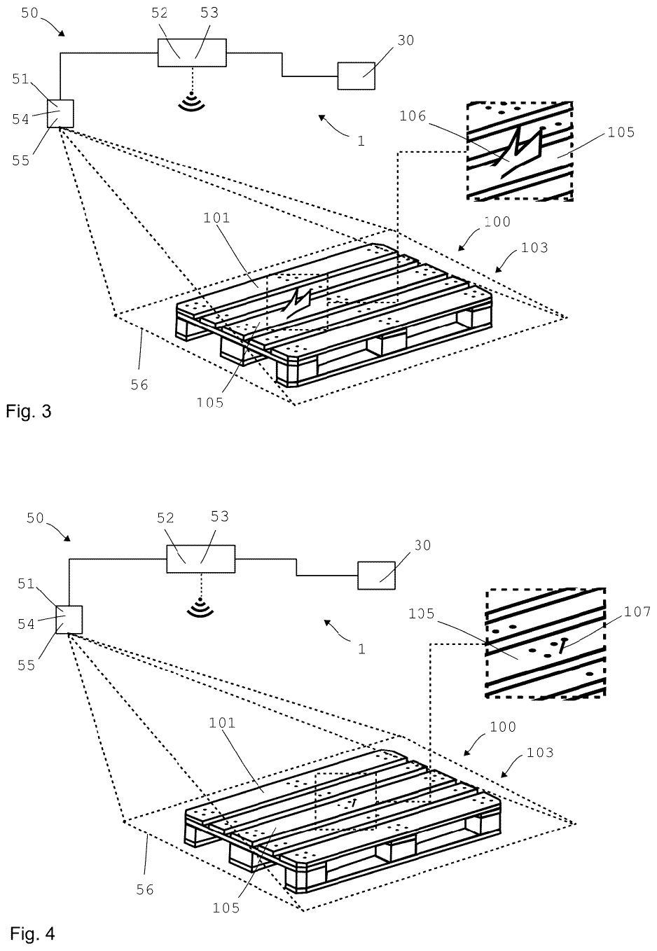

FIG. 3 shows a purely schematic illustration of the exemplary embodiment according to FIG. 1 with another defective load carrier;

FIG. 4 shows a purely schematic illustration of the exemplary embodiment according to FIG. 1 with another defective load carrier; and

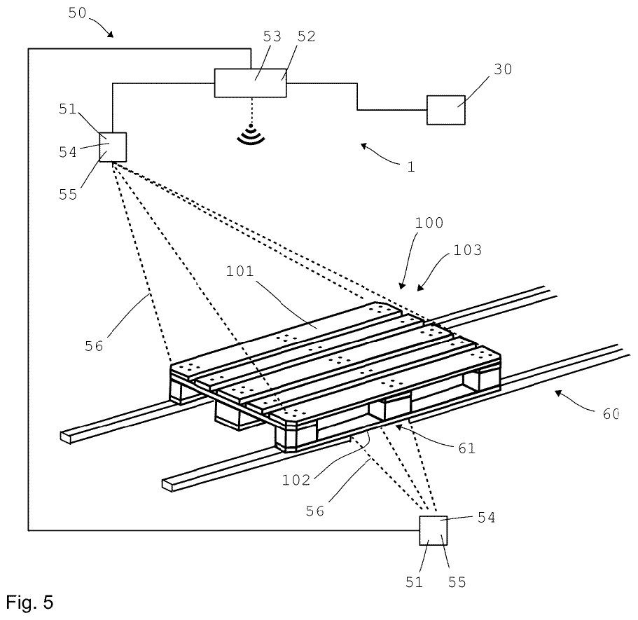

FIG. 5 shows a purely schematic illustration of another exemplary embodiment of a load carrier control apparatus according to the invention in a perspective view.

FIG. 1 illustrates purely schematically a load carrier control apparatus 1 according to the invention with a load carrier 100 to be inspected in a (partial) perspective view.

In the exemplary embodiment shown, the integrity in particular of the upper side 101 of the load carrier 100 is to be inspected by means of the load carrier control apparatus according to the invention. In the exemplary embodiment shown, the load carrier is a so-called Euro pallet 103, which is a special or standardized type of flat pallet made of wood.

In the exemplary embodiment shown here, the load carrier control apparatus 1 comprises a control device 50, which in this case comprises a sensor device 51 and a computing device 52. In the exemplary embodiment shown here, the computing device 52 is a computer 53, which is online or connected to the Internet, as indicated by the corresponding symbol.

The sensor device 51 in the exemplary embodiment shown here comprises a camera device 54, which is designed here as a conventional webcam 55. By means of this sensor device 51 or the camera device 54, the empty load carrier 100 to be controlled or a corresponding detection area 56 can be recorded and/or set.

Depending on the configuration, the detection area 56 corresponds to the entire recording area of the camera device 54. However, it is also possible and generally provided that a larger image section is narrowed down to a specific detection area 56 as part of the image processing by the computing device 52 and/or a user. The images or image data captured by the sensor device 51 or the camera device 54 or the webcam 55 are inspected for defects by the computing device 52 or the computer 53 by means of an automated application comprising at least one AI application and/or a computer vision application. In particular, it is inspected whether certain quality features are complied with or, conversely, by detecting any defects, whether at least the upper side 101 of the empty load carrier 100 or the pallet 103 complies with all predetermined quality requirements.

Furthermore, a controller 30 is provided here, which is comprised in the load carrier control apparatus 1 in the exemplary embodiment shown here. This controller 30 is in operative connection with the control device 50 or with the computing device 52, whereby the evaluation created by the computing device 52 can be transmitted to the controller 30.

The controller 30 can perform a predetermined action based on the evaluation of the computing device 52 in the exemplary embodiment shown. For example, a warning signal can be output, or, in the case of an automated transport system for load carriers, this transport system can be stopped or, for example, a pallet or a defective load carrier 100 detected as defective can be ejected from the transport system or a conveyor device so that it is no longer used.

FIG. 2 shows the exemplary embodiment according to FIG. 1 again, wherein a load carrier 100 or a Euro pallet 103 that does not meet the quality requirements is controlled here.

The exemplary embodiment shown here illustrates that the detection area 56 can also be used to detect that not all components of the pallet 103 or load carrier 100 are present, which impairs stability. In the exemplary embodiment shown, two corner blocks 104 are missing, so that the slats 105 otherwise connected thereto do not have sufficient stability.

FIG. 3 shows again the exemplary embodiment of a load carrier control apparatus 1 according to the invention as shown in FIG. 1, wherein a different defect of a pallet 103 or a load carrier 100 is shown here in purely schematic form.

In the exemplary embodiment shown here, a slat 105 is splintered or partially broken, so that a large splinter 106 protrudes upwards, which could damage the load to be picked up. The splintered area is also shown in the enlarged view.

In particular when loading bags filled with bulk material, damage to a bag can occur so that bulk material could spill out, which could cause contamination or even a hazard.

In FIG. 4, the exemplary embodiment according to FIG. 1 is illustrated again, wherein another defect of a load carrier 100 or a pallet 103 is shown by way of example, which can be detected.

In the exemplary embodiment shown here, as can be seen particularly well in the enlarged view, a protruding nail 107 is detected. Such a nail 107 or another foreign body protruding from the upper side 101 of the load carrier 100 could also cause damage, in particular to bags filled with bulk material, which could result in the disadvantages already described above.

FIG. 5 shows, in purely schematic form, another exemplary embodiment of a load carrier control apparatus 1 according to the invention, which corresponds in its basic structure to the exemplary embodiment shown above.

In the exemplary embodiment shown it is also illustrated that the load carrier control apparatus 1 can comprise a conveyor device 60 or is assigned to such a conveyor device 60.

Load carriers 100 and, in the exemplary embodiment shown, pallets or Euro pallets 103 are transported via such a conveyor device 60 from a warehouse to a loading location, for example. Here too, the upper side 101 and also the sides of the load carrier 100 are inspected by means of a first sensor device 51 or a camera device 54 or, in this case, a webcam 55.

In contrast to the previously shown exemplary embodiment, the control device 50 here comprises a second sensor device 51 or camera device 54 or webcam 55. The second camera device 54 is provided in such a manner that the detection area 56 of this camera device 54 can record at least sections of the underside 102 of the load carrier 100 or the Euro pallet 103.

It is shown in the exemplary embodiment shown here that the conveyor device 60 has a recess 61, so that the camera device 54 can inspect or control the underside 102 of the load carrier in sections while the load carrier 100 is being conveyed via the conveyor device 60 when the respective section of the pallet 103 is conveyed across the recess 61 of the conveyor device 60.

Alternatively, such a load carrier control apparatus 1 can also comprise a rotating device or be assigned to such a rotating device in order to examine all freely accessible surfaces, in particular the surface 101 and the side surfaces, from one camera position and thus with only one camera. Controlling the underside (102) can then be carried out, for example, by turning the load carrier 100 completely around and/or lifting or tilting the load carrier 100 at least temporarily, for example by 90°, around a longitudinal side.

### REFERENCE LIST

1 load carrier control apparatus
30 controller
50 control device
51 sensor device
52 computing device
53 computer
54 camera device
55 webcam
56 detection area
60 conveyor device
61 recess
100 load carrier
101 upper side
102 underside
103 pallet/Euro pallet
104 block
105 slat
106 splinter
107 nail

1. A load carrier control apparatus comprising: at least one control device, wherein the control device comprises at least one sensor device and at least one computing device;
the computing device is suitable and designed for using an evaluation based on at least one automated application to inspect at least one quality feature of at least the upper side of at least one empty load carrier to be controlled, on the basis of the data captured by the sensor device; wherein the automated application comprises at least one of at least one AI application at least one computer vision application.

2. The load carrier control apparatus according to claim 1, wherein the control device is in operative connection with at least one controller, wherein the evaluation of the automated application can be transmitted to the controller.

3. The load carrier control apparatus according to claim 1, wherein the sensor device comprises at least one camera device

4. The load carrier control apparatus according to claim 1, further including at least one conveyor device for load carriers to be controlled.

5. The load carrier control apparatus according to the claim 4, wherein the conveyor device is suitable and designed, at least in sections and/or at least temporarily, to release the underside of the conveyed load carrier for the control.

6. The load carrier control apparatus according to claim 1, wherein the control device is suitable and designed to detect at least one of a protruding nail, a broken and/or splintered slat, a foreign body, a deformed and/or damaged surface and a missing component as a quality feature.

7. A method for operating a load carrier control apparatus according to claim 1, wherein
at least one quality feature of an empty load carrier to be controlled is inferred by the control device based on the evaluation of the data of the sensor device using the automated application, and an accordingly predetermined action is initiated; wherein the automated application comprises at least one of at least one AI application and at least one computer vision application.

8. The method according to claim 7, wherein the automated application inspects the data online.

9. The method according to claim 7, wherein the automated application is taught by training and/or operates offline on the computing device.

10. The method according to claim 7, wherein the automated application is taught by re-training.

11. The method according to claim 7, wherein at least one of a protruding nail, a broken slat, a splintered slat, a foreign body, a deformed surface, a damaged surface and a missing component is detected as a quality feature.

12. A use of an automated application, comprising: at least one of at least one AI application and at least one computer vision application in the control of empty load carriers.
